(19) United States
(12) Patent Application Publication
(10) Pub. No.: US 2009/0052537 A1
(43) Pub. Date: Feb. 26, 2009

(54) METHOD AND DEVICE FOR PROCESSING CODED VIDEO DATA

(75) Inventors: Dzevdet Burazerovic, Eindhoven (NL); Mauro Barbieri, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/718,248

(22) PCT Filed: Oct. 28, 2005
(86) PCT No.: PCT/IB2005/053534

§ 371 Date: Apr. 30, 2007

(30) Foreign Application Priority Data
Nov. 4, 2004 (EP) 04300758.2

(51) Int. Cl. H04N 11/02

(52) U.S. Cl. 375/240.15; 375/E07.243

(57) ABSTRACT

The present invention relates to a method of processing digital coded video data available in the form of a video stream consisting of consecutive frames divided into slices. The frames include at least I-frames, coded without any reference to other frames, P-frames, temporally disposed between said I-frames and predicted from at least a previous I- or P-frame, and B-frames, temporally disposed between an I-frame and a P-frame, or between two P-frames, and bidirectionally predicted from at least these two frames between which they are disposed. The processing method comprises the steps of determining for each slice of the current frame related slice coding parameters and parameters related to spatial relationships between the regions that are coded in each slice, collecting said parameters for all the successive slices of the current frame, for delivering statistics related to said parameters, analyzing said statistics for determining regions of interest (ROIs) in said current frame, and enabling a selective use of the coded data, targeted on the regions of interest thus determined.

### FIELD OF THE INVENTION

The invention relates to a method of processing digital coded video data available in the form of a video stream consisting of consecutive frames divided into slices, said frames including at least I-frames, coded without any reference to other frames, P-frames, temporally disposed between said I-frames and predicted from at least a previous I- or P-frame, and B-frames, temporally disposed between an I-frame and a P-frame, or between two P-frames, and bidirectionally predicted from at least these two frames between which they are disposed.

### BACKGROUND OF THE INVENTION

Content analysis techniques are based on algorithms such as multimedia processing (image and audio processing), pattern recognition and artificial intelligence that aim at automatically create annotations of video material. These annotations vary from low-level signal related properties, such as color and texture, to higher-level information, such as presence and location of faces. The results of the content analysis thus performed are used for many content-based applications such as commercial detection, scene-based chaptering, video previews and video summaries.

Both the established standards (e.g. MPEG-2, H.263) and the emerging standards (e.g. H.264/AVC, shortly described for instance in: “Emerging H.264 standard: Overview” and in TMS320C64xDigital Media Platform Implementation—white paper, at: http:///www.ubvideo.com/public) inherently use the concept of block-based motion-compensated coding. Accordingly, video is represented as a hierarchy of syntax elements describing picture attributes (e.g. size and rate) and spatio-temporal interrelationships and decoding procedure for the building 2D data blocks that will ultimately compose an approximation of the original signal. The first step in obtaining such a representation is the conversion of the RGB data matrix of a picture into a YUV matrix (the RGB color space representation is most used for image acquisition and rendering), so that the luminance (Y) and the two chrominance components (U, V) can be coded separately. Usually, the U and V frames are first down-sampled by a factor of 2 in the horizontal and vertical directions, to obtain the so-called 4:2:0 format and thereby half the amount of data to be coded (this is justified by the relatively lower susceptibility of the human eye to color changes compared to changes in the luminance). Each of the frames is further divided into a plurality of non-overlapping blocks, sizing 16×16 pixels for the luminance and 8×8 pixels for the downsized chrominance. The combination of a 16×16 luminance block and the two corresponding 8×8 chrominance blocks is designated as a macroblock (or MB), the basic encoding unit. These conventions are common to all standards, and the differences between the various encoding standards (MPEG-2, H.263 and H.264/AVC) mainly concern the options, techniques and procedures for partitioning a MB into smaller blocks, for coding the sub-blocks, and for organizing the bitstream.

Without going into details of all coding techniques, it can be pointed out that all standards use two basic types of coding: intra and inter (motion-compensated). In the intra mode, pixels of an image block are coded by themselves, without any reference to other pixels, or possibly based (only in H.264) on prediction from previously coded and reconstructed pixels in the same picture. The inter mode inherently uses temporal prediction, whereby an image block in a certain picture is predicted by its “best match” in a previously coded and reconstructed reference picture. There, the pixel-wise difference (or prediction error) between the actual block and its estimate and the relative displacement of the estimate (or motion vector) with respect to the coordinates of the actual block are coded separately.

Depending on the coding type, three basic types of pictures (or frames) are defined: I-pictures, allowing only intra coding, P-pictures, allowing also inter coding based on forward prediction, and B-pictures, further allowing inter coding based on backward or bi-directional prediction. FIG. 1 illustrates for instance the bi-directional prediction of the B-picture Bᵢ₊₂ from two reference P-pictures Pᵢ₊₁ and Pᵢ₊₃, the motion vectors being indicated by the curved arrows and Iᵢ, Iⱼ designating the two successive I-pictures between which these P- and B-pictures are located. Each block of any B-picture can be predicted by a block from the past P-picture, or one from the future P-picture, or by an average of two blocks, each from a different P-picture. To provide support for fast search, editing, error resilicence, etc., a sequence of coded video pictures is usually divided into a series of Groups of Pictures, or GOPs (FIG. 1 illustrates the i-th GOP of the concerned video sequence). Each GOP begins with an I-picture followed by an arrangement of P- and, optionally, B-pictures. In FIG. 2, Iᵢ is the start picture of the illustrated i-th GOP, and Iⱼ will be the start picture of the following GOP, not shown. Furthermore, each picture is divided into non-overlapping strings of consecutive MBs, i.e. slices, such that different slices of a same picture can be coded independently from each other (a slice can also contain the whole picture.) In MPEG-2, the left edge of a picture always starts a new slice, and a slice always runs from left to right across the picture. In other standards, more flexible slice constructions are also feasible, and for H.264 this will be explained below in more detail.

Hence, the coded video sequence is defined with a hierarchy of layers (FIG. 2 illustrates this in the case of H.263 bitstream syntax) including: sequence-, GOP-, picture-, slice-, macroblock- and block layer, where each layer includes the descriptive header data. For example, the picture layer PL will include 22-bit Picture Start Code (PSC) for identifying the start of the picture, the 8-bit Temporal Reference (TR) for aligning the decoded pictures in their original order (when using B-pictures, the coding order is not the same as the display order), etc. The slice layer, or in this case the Group of Blocks layer or GOBL (a GOB includes k×16 lines of a picture), includes code words for indicating the beginning of a GOB (GBSC), the number of GOBs in the picture (GN), the picture identification for a GOB (GFID), etc. Finally, the macroblock layer (MBL) and the block layer (BL) will include the coding type information and the actual video data, such as motion vector data (MVD), at the macroblock level, and transform coefficients (TCCOEF), at the block layer level.

H.264/AVC is the newest joint video coding standard of ITU-T and ISO/TEC MPEG, which has been recently officially approved as ITU-T Recommendation H.264/AVC and ISO/FEC International Standard 14496-10 (MPEG-4 Part 10) Advanced Video Coding (AVC). The main goals of the H.264/AVC standardization have been to significantly improve compression efficiency (by halving the number of bits needed to achieve a given video fidelity) and network adaptation. Presently, H.264/AVC is broadly recognized for achieving these goals, and it is currently being considered, by forums such as DVB, DVD Forum, 3GPP, for adoption in several application domains (next generation wireless communication, videophony, HDTV storage and broadcast, VOD, etc.). On the Internet, there is a growing number of sites offering information about H.264/AVC, among which an official database of ITU-T/MPEG JVT [Joint Video Team] (Oficial H.264 documents and software of the JVT at: ftp://ftp.imtc-files.org/jvt-experts/) provides free access to documents reflecting the development and status of H.264/AVC, including the draft updates.

The aforementioned flexibility of H.264 to adapt to a variety of networks and to provide robustness to data errors/losses adaptation and robustness is enabled by several design aspects among which the following ones are most relevant for the invention which is described some paragraphs later:

(a) NAL units (NAL=Netword Abstraction Layer): a NAL unit (NALU) is the basic logical data unit in H.264/AVC, effectively composed of an integer number of bytes including video and non-video data. The first byte of each NAL unit is a header byte that indicates the type of data in the NAL unit, and the remaining bytes contain the payload data of the type indicated by the header. The NAL unit structure definition specifies a generic format for use in both packet-oriented (e.g. RTP) and bitstream-oriented (e.g. H.320 and MPEG-2|H.222) transport systems, and a series of NALUs generated by an encoder are referred to as a NALU stream.

(b) Parameter sets: a parameter set will contain information that is expected to rarely change and will apply to a larger number of NAL units. Hence, the parameter set can be separated from other data, for more flexible and robust handling (in the previous standards, the header information is repeated more frequently in the stream, and the loss of few key bits of such information could have a severe negative impact on the decoding process). There are two types of parameter sets: the sequence parameter sets, that apply to series of consecutive coded pictures called a sequence, and the picture parameter sets, that apply to the decoding of one or more pictures within a sequence.

(c) Flexible macroblock ordering (FMO): FMO refers to a new ability to partition a picture into regions called slice groups, with each slice becoming an independently-decodable subset of a slice group. Each slice group is a set of macroblocks defined by a macroblock to slice group map, which is specified by the content of the picture parameter set (see above) and some information from slice headers. Using FMO, a picture can be split into many macroblock scanning patterns, such as e.g. those shown in FIG. 3 (that gives some examples of subdivision of a picture into slices when using FMO), which can significantly enhance the ability to manage spatial relationships between the regions that are coded in each slice.

Recent advances in computing, communications and digital data storage have led to a tremendous growth of large digital archives in both the professional and the consumer environment. Because these archives are characterized by a steadily increasing capacity and content variety, finding efficient ways to quickly retrieve stored information of interest is of crucial importance. Searching manually through terabytes of unorganized stored data is however tedious and time-consuming, and there is consequently a growing need to transfer information search and retrieval tasks to automated systems.

Search and retrieval in large archives of unstructured video content is usually performed after the content has been indexed using content analysis techniques, based on algorithms such as indicated above. Detecting the presence and location of particular objects (e.g. faces, superimposed text) and tracking them among video frames is an important task for automatic annotation and indexing of content. Without any a priori knowledge of the possible location of objects, object detection algorithms need to scan the entire frames, with therefore a considerable consumption of computational resources.

### SUMMARY OF THE INVENTION

It is an object of the invention to propose a method allowing to detect with a better computational efficiency the use of regions of interest (ROI) coding in H.264/AVC video, by looking at the stream syntax.

To this end, the invention relates to a processing method such as defined in the introductory paragraph of the description and which comprises the steps of:
determining for each slice of the current frame related slice coding parameters and parameters related to spatial relationships between the regions that are coded in each slice;
collecting said parameters for all the successive slices of the current frame, for delivering statistics related to said parameters;
analyzing said statistics for determining regions of interest (ROIs) in said current frame;
   enabling a selective use of the coded data, targeted on the regions of interest thus determined.

Content analysis algorithms (e.g. face detection, object detection, etc.) including this technical solution can focus in the regions of interest rather than scan blindly the whole picture. Alternatively, content analysis algorithms could be applied in different regions in parallel, which would increase the computational efficiency.

### BRIEF DESCRIPTION OF THE DRAWINGS

The present invention will now be described, by way of example, with reference to the accompanying drawings in which:

FIG. 1 shows an example of GOP of a video sequence and illustrates the bi-directional prediction of a B-picture of said GOP;

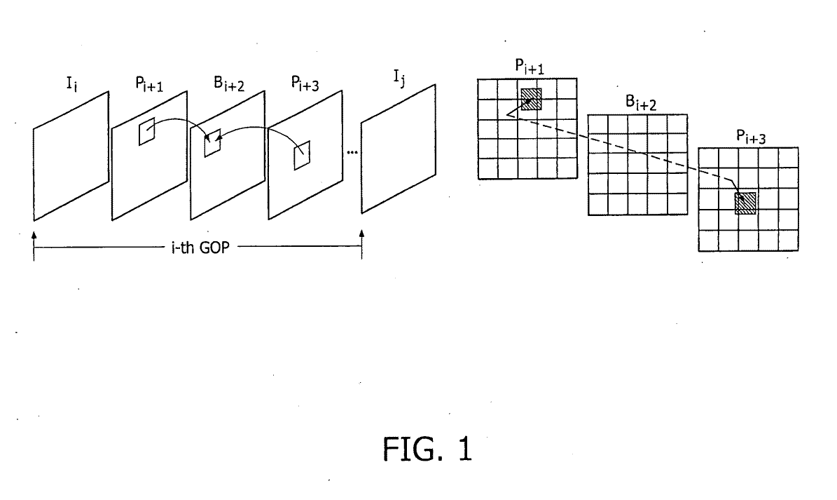

FIG. 2 illustrates the hierarchy of layers in a sequence and some code words used in these layers in the case of H.263 bitstream syntax;

FIG. 3 gives some examples of subdivision of a picture into slices when using flexible macroblock ordering;

FIG. 4 is a block diagram of an example of a device for the implementation of the processing method according to the invention;

FIG. 5 shows an excerpt from a video sequence where ROI coding using FMO is convenient;

FIGS. 6 and 7 illustrate an example of strategy for localizing possible regions of interest in H.264 video and show the processing steps that could enable detection of region-of-interest encoding.

### DETAILED DESCRIPTION OF THE INVENTION

Considering the described ability of FMO to flexibly slice a picture, it is expected that the FMO will be largely exploited for ROI type of coding. This type of coding refers to unequal coding of video or picture segments, depending on the content (for example, in videoconferencing applications: picture regions capturing the face of a speaker can be coded with better quality compared to the background). The FMO could be applied here, in such a way that a separate slice in each picture would be assigned to the region encompassing the face, and a smaller quantization step can further be chosen in such a slice, to enhance the picture quality.

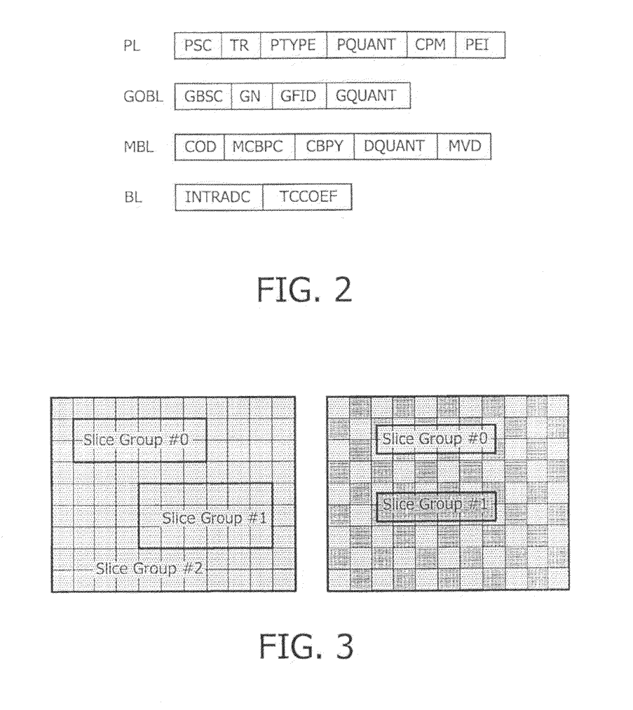

Based on this consideration, it is proposed to analyze the FMO usage in the stream, as a means to indicate that ROI coding may have been applied in a certain part of the stream. To enhance ROI indication, and eventually enable detection of ROI boundaries, the FMO information is combined with the information extracted from slice headers and possible other data in the stream characterizing a slice. This additional information may relate to physical attributes of a slice, such as the size and the relative position in the picture, or coding decisions, such as the default quantization scale for the macroblocks contained in the slice (e.g. “GQUANT” in FIG. 2). The central idea is thus to analyze, throughout a series of consecutive pictures, the statistics of syntax elements related to FMO and the slice layer information. Once a certain consistency or pattern in these statistics has been observed, it will be a good indication of ROI coding in that part of the content. For example, the above-described use of FMO in videoconferencing can be easily detected by such an approach.

An application that can largely benefit from the proposed detection of ROI coding is content analysis. For example, a typical goal of content analysis in many applications is face recognition, which is usually preceded by separately performed face detection. The method described here may in particular be exploited in the latter, in such a way that the face detection algorithm would be targeted on few most important slices, rather than being applied blindly across the whole picture. Alternatively, the algorithms could be applied in different slices in parallel, which would increase the computational efficiency. ROI coding may be also used in other applications than in videoconferencing. For example, in movie scenes, parts of the content are often in focus and other parts are out of focus, which often corresponds to the separation of the foreground and background in a scene. Hence, it is conceivable that these parts may be separated and unequally coded during the authoring process. Detecting such ROI coding by means of the present method can be helpful in enabling more selective use of the content analysis algorithms.

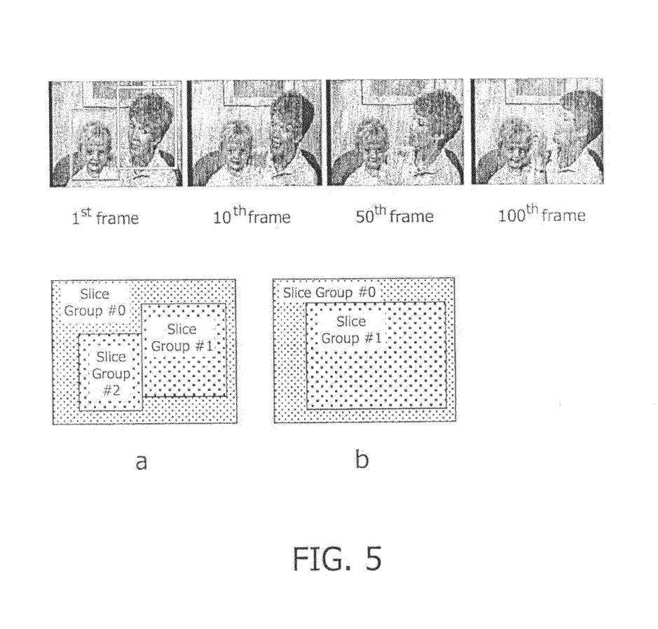

A processing device for the implementation of the method according to the invention is shown in FIG. 4, that illustrates, for example in the case of an H.264/AVC bitstream, the concept previously explained (said example is however not a limitation of the scope of the invention). In the illustrated device, a demultiplexer 41 receives a transport stream TS and generates demultiplexed audio and video streams AS and VS. The audio stream AS is sent towards an audio decoder 52 which generates a decoded audio stream DAS processed as described later in the description (in circuits 44 and 45). The video stream VS is received by an H.264/AVC decoder 42 for delivering a decoded video stream DVS also received by the circuit 44. This decoder 42 mainly comprises an entropy decoding circuit 421, an inverse quantization circuit 422, an inverse transform circuit 423 (inverse DCT circuit) and a motion compensation circuit 424. In the decoder 42, the video stream VS is also received by a so-called Network Abstraction Layer Unit (NALU) 425, provided for collecting the received coding parameters related to FMO.

The output signals of said unit 425 are a statistical information related to FMO. Said information is received by a ROI detection and identification circuit 43 which combines this FMO information with an information extracted from the entropy decoding circuit 421 and related to some structural attributes of the slices of the pictures (such as their size and their relative positions in the pictures, the default quantization scale for macroblocks within a certain slice, the macroblock to slice group map characterizing FMO, etc, said attributes being called slice coding parameters). It can be noted that the FMO information is conveyed by a parameter set which, depending on the application and transport protocol, may be either multiplexed in the H.264/AVC stream or transported separately through a reliable channel RCH, as illustrated in dotted lines in FIG. 4.

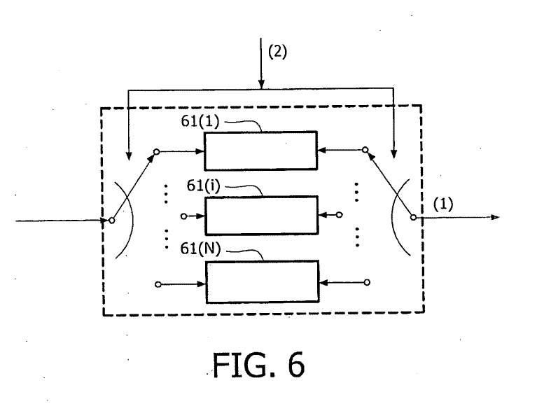

As said above, the principle of the invention is to analyze through a series of consecutive pictures the statistics of syntax elements related to FMO and the slice layer information (and possibly other data in the stream characterizing a slice), said analysis being for instance based on comparisons with predetermined thresholds. For example, the presence of FMO will be inspected, and the amount by which the number, the relative position and the size of slices may change along a number of consecutive pictures will be analyzed, said analysis in view of the detection and identification of the use of ROIs in the coded stream being done in the ROI detection and identification circuit 43. In the case of the H.264 standard, the central idea of the invention is to detect potential ROIs by detecting the use of FMO along a series of consecutive H.264-coded pictures, and to employ statistical analysis of the amount by which the number, relative position and size of such flexible slices may change from picture to picture. All the relevant information can be extracted by parsing the relevant syntax elements from the H.264 bitstream. An example is illustrated in FIGS. 5 to 7 below.

FIG. 5 shows an excerpt from a video sequence where ROI coding could be convenient (in the illustrating example, the excerpt comprises the frames number 1, 10, 50 and 100 of the sequence). The ROIs, in this case faces, can be separated from the background using FMO slicing such as e.g. shown in (a) and (b), the option (a) apparently providing more options to vary coding decisions, i.e. picture quality, for each of the faces. Several mappings of ROIs to FMO slice structure are feasible. It is obvious that the ROIs, in this case faces, and their spatial locations in each picture can be rather stationary over a large number of pictures. Hence, the FMO slice structure, that is the relative size and position of each of the “Slice Groups”, is also expected to not change much from picture to picture.

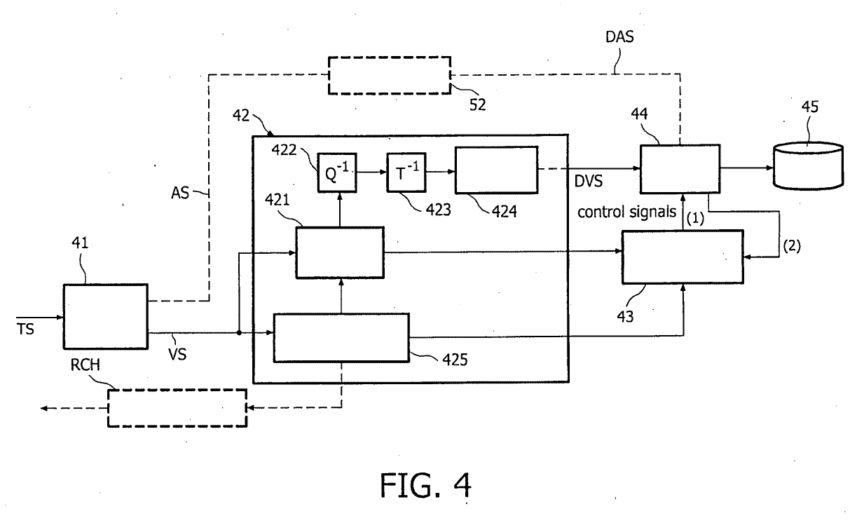

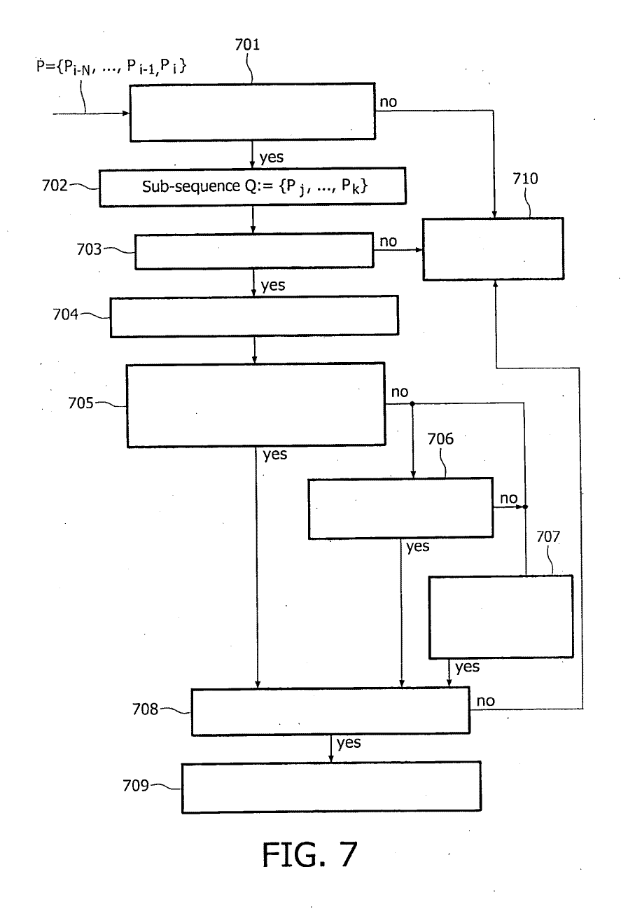

FIGS. 6 and 7 roughly illustrate the processing steps that could enable detection of ROI encoding, as proposed. Basically, they illustrate a possible strategy for localizing potential ROIs in H.264 video (and in particular for face tracking in videoconferencing and videophone applications), and they give a more detailed view of the ROI detection and identification circuit 43 of FIG. 4, reusing some of the notation from there. In the present case, the “FMO and slice information” that will be extracted by parsing an incoming H.264 bitstream will mainly refer to:
the size of any picture in the stream, or the size and rate for a number of consecutive pictures (conveyed separately via the picture parameter set);
information about the assignment of each macroblock in a picture to a slice group (contained in the macroblock allocation map, i.e. MBA map);
information about the quality of encoding of each macroblock in a picture, e.g. coding decisions regarding the macroblock quantization scale;
   Using all this information and the fact that the size of a macroblock is fixed and known to be 16×16 pixels, one can derive the relevant information, such as:
number of slices in each picture;
macroblock scanning patterns in each of the slices, e.g. “check-board” versus “rectangular and filled” (see FIG. 3);
size and relative position (i.e. the distance from the picture boarders) of each “rectangular and filled” slice in the picture;
statistics of macroblock level coding decisions within a single slice (e.g. the macroblock quantization parameter);
similarities/discrepancies in the slice-level coding decisions (e.g. the average quantization parameter for all macroblocks in a slice).
   This above-listed information is apparently already sufficient to detect the ROI coding of faces according to FIG. 5.

Looking into more detail of how the relevant information is evaluated to arrive at the final decision, different strategies are feasible. In FIG. 6 showing an example of circuit 43, it is illustrated as an option to switch between one or more analyzers 61(1), . . . , 61(i), . . . , 61(N) (in practice, it is certainly feasible to implement different analyzers on a same device, especially in software). The external information governing the choice of the analyzer could be for example a notion or knowledge of the application. So, it is conceivable that the present system may know beforehand whether the incoming H.264 bitstream corresponds to, say, recording of a videoconference or a dialog from a DVD movie scene (as explained above, such cues could also be obtained by applying “external” content analysis, also involving the audio data accompanying the H.264 video).

An example of a possible embodiment of a dedicated ROI analyzer will be now described. FIG. 7 gives a simplified view of an illustrating implementation, taking the example of videoconferencing/videophone (this example is obviously not a limitation of the scope of the invention, and other ones are conceivable, depending on the precise application). The explanation of the decision logic is straightforward, considering that in these applications it is most often only one speaker that is in picture at a certain time, and pictures are captured with only minor movement of the camera. As ROI coding will typically be employed to separate the speaker from the background, the picture slicing structure can be expected to only gradually change over time. The significance of “check-board” macroblock ordering is explained by the fact that even when loosing one of the two slice groups (Slice Group #0 or Slice Group #1 in FIG. 3), each lost (inner) MB has four neighbouring MBs that can be used to conceal the lost information. Therefore, this construction seems very attractive for ROI coding in error prone environments. Clearly, different strategies could be employed for face detection in movie dialogs, depending on the expected number of speakers (e.g. pre-estimated by means of speech detection and speaker-tracking/verification). Also a more complex decision logic could be implemented, combining more criteria and decisions at a same time.

The decision logic in anyone of the analyzers 61(1) to 61(N) of FIG. 6 may be for instance illustrated by the set of steps shown in FIG. 7. In said FIG. 7, QUANT is a notation for the quantization parameter, the choice of which directly reflects the quality of the encoding process, i.e. the picture quality (generally, the lower the quantization step, the better the quality). Therefore, if the average quantization for all blocks in a given slice is consistently and substantially lower than the average quantization elsewhere in the picture, it means that this slice may have been deliberately encoded with better quality and may therefore contain a ROI (in the example of FIG. 5, if the average QUANT is e.g. 24.43 for SliceGroup#0 and 16.2 for SliceGroup#1, with a threshold set for instance to 1.5, the condition is then met since 24.43/16.2=1.5; other constructions for testing the QUANT are however also possible). It can be still added that the choice of QUANT is only one of the possible coding decisions that directly reflect picture quality. Another one is for instance the intra/inter decision for a macroblock or a sub-block thereof: if a large number of macroblocks are repetitively intra coded—i.e. without any temporal reference to neighbouring pictures—in a same slice, even in inter B- and P-pictures, this may indicate that the slice is more often refreshed to avoid accumulation of motion estimation errors and may therefore correspond to a ROI. Other possible coding decisions can still be chosen in H.264 for reflecting the coding quality.

In the example illustrated with reference to FIG. 7, the decision logic in anyone of the analyzers 61(1) to 61(N) may comprise for instance the following steps Input: sequence P={P_{i-N}, . . . , Pᵢ₋₂, Pᵢ₋₁, P₁}.
701: is the number of consecutive pictures which, in said sequence, have a same number of slices greater than a given threshold T?
if no, exit or take a new input sequence (=step 710);
if yes, step 702 (i.e. consider the sub-sequence Q={Pⱼ, . . . , Pₖ}, followed by step 703;
703: is the number of slices in a picture of Q equal to 2?
if no, step 710;
if yes, step 704 (i.e. consider the slice Sⱼ from picture Pₖ in Q), followed by step 705;
705: is the variance of the size and relative position of Sⱼ measured along all pictures of Q lower than a value Y?
if no, step 706 (or step 707);
if yes, step 708;
706: has the slice Sⱼ a cbeckboard MB allocation?
if no, step 707;
if yes, step 708;
707: is the value of QUANT in Sⱼ relatively higher by a factor greater than a threshold R?
if yes, step 708;
708: are at least 2 out of 3 “yes” (from the outputs of steps 705, 706, 707) received?
if no, step 710;
if yes, step 709, i.e. it has-been detected that “the slice Sⱼ in the sub-sequence Q encloses a potential ROI”.
   It has however been seen above that this example is not a limitation of the scope of the invention and that a more sophisticated decision logic could be implemented (e.g. fuzzy logic).

Once a consistency of the statistics has been established, it is a good indication of ROI coding in that part of the content: the slices are coincided with ROIs and this information is passed to enhance a content analysis performed in a content analysis circuit 44. The circuit 44 therefore receives the output of the circuit 43 (control signals sent by means of the connection (1)), the decoded video stream DVS delivered by the-motion compensation circuit 424 of the decoder 42, and the decoded audio stream DAS delivered by the audio decoder 52, and, on the basis of said information, identifies the genre of a certain content (such as news, music clips, sport, etc. . . . ). The output of the content analysis circuit 44 is constituted of metadata, i.e. of description data of the different levels of information contained in the decoded stream, which are stored in a file 45, e.g. in the form of the commonly used CPI (Characteristic Point Information) table. These metadata are then, now, available for applications such as video summarization and automatic chaptering (it can be recalled, however, that the invention is especially useful in the case of videoconferencing, where it is a common approach to detect and track the face of a speaker such that picture regions corresponding to the face can be coded with better quality, or more robustly, compared to regions corresponding to the background).

In an improved embodiment, the output of the content analysis circuit 44 can be transmitted back (by means of the connection (2)) to the ROI detection and identification circuit 43, which can provide an additional clue about e.g. the likeliness of ROI coding in that content.

1. A method of processing digital coded video data available in the form of a video stream consisting of consecutive frames divided into slices, said frames including at least I-frames, coded without any reference to other frames, P-frames, temporally disposed between said I-frames and predicted from at least a previous I- or P-frame, and B-frames, temporally disposed between an I-frame and a P-frame, or between two P-frames, and bidirectionally predicted from at least these two frames between which they are disposed, said processing method comprising the steps of:
determining for each slice of the current frame related slice coding parameters and parameters related to spatial relationships between the regions that are coded in each slice;
collecting said parameters for all the successive slices of the current frame, for delivering statistics related to said parameters;
analyzing said statistics for determining regions of interest (ROIs) in said current frame;
enabling a selective use of the coded data, targeted on the regions of interest thus determined.

2. A processing method according to claim 1, in which the syntax and semantics of the processed video stream are those of the H.264/AVC standard.

3. A device for processing digital coded video data available in the form of a video stream consisting of consecutive frames divided into slices, said frames including at least I-frames, coded without any reference to other frames, P-frames, temporally disposed between said I-frames and predicted from at least a previous I- or P-frame, and B-frames, temporally disposed between an I-frame and a P-frame, or between two P-frames, and bidirectionally predicted from at least these two frames between which they are disposed, said device comprising the following means:
determining means, provided for determining for each slice of the current frame related slice coding parameters and parameters related to spatial relationships between the regions that are coded in each slice;
collecting means, provided for collecting said parameters for all the successive slices of the current frame, for delivering statistics related to said parameters;
analyzing means, provided for analyzing said statistics for determining regions of interest (ROIs) in said current frame;
activating means, provided for enabling a selective use of the coded data, targeted on the regions of interest thus determined.

4. A computer program product for a video processing device arranged to process digital coded video data available in the form of a video stream consisting of consecutive frames divided into slices, said frames including at least I-frames, coded without any reference to other frames, P-frames, temporally disposed between said I-frames and predicted from at least a previous I- or P-frame, and B-frames, temporally disposed between an I-frame and a P-frame, or between two P-frames, and bidirectionally predicted from at least these two frames between which they are disposed, said computer program product comprising a set of instructions which are executable by a computer and which, when loaded in the videoprocessing device, cause said video processing device to carry out the steps of:
determining for each slice of the current frame related slice coding parameters and parameters related to spatial relationships between the regions that are coded in each slice;
collecting said parameters for all the successive slices of the current frame, for delivering statistics related to said parameters;
analyzing said statistics for determining regions of interest (ROIs) in said current frame;
enabling a selective use of the coded data, targeted on the regions of interest thus determined.
